(19) United States
(12) Patent Application Publication
(10) Pub. No.: US 2004/0235567 A1
(43) Pub. Date: Nov. 25, 2004

(54) Video game method and system with content-related options

(75) Inventor: Masayuki Chatani, Foster City, CA (US)

Correspondence Address: MARTINE & PENILLA, LLP, 710 LAKEWAY DRIVE, SUITE 170, SUNNYVALE, CA, 94085, US

(73) Assignee: Sony Computer Entertainment America Inc., Foster City, CA

(21) Appl. No.: 10/442,428

(22) Filed: May 20, 2003

(51) Int. Cl. A63F 13/00

(52) U.S. Cl. 463/42

(57) ABSTRACT

A method for providing media content-related options in conjunction with video game use is provided. The method includes identifying video game content of a video game and identifying commercial media content that is related to the video game content. The method further includes displaying an interactive menu through a screen of the video game. The interactive menu itemizes selectable commercial media content and provides a link to a commercial Internet website to enable purchase of the commercial media content.

### BACKGROUND OF THE INVENTION

1. Field of the Invention

This invention relates generally to interactive content with content-related options, and more particularly to methods and systems for providing options to obtain and locally store additional digital content that is at least partially related to the content of a video game.

2. Description of the Related Art

Currently, interactive content systems, such as video game consoles, provide utility and entertainment mechanisms to individuals worldwide. For example, interactive content of such systems allow users to view digital video discs (DVDs), play interactive entertainment software such as games, browse the Internet, and play on-line video games.

FIGS. 1A and 1B are diagrams showing a typical interactive content system 100, such as for playing a video game. FIG. 1A shows the prior art interactive content system 100 generally including a game console 101. An exemplary game console may be Sony's Playstation or Playstation2 system. FIG. 1B shows a simplified game console 101 having at least a central processing unit (CPU) 102 coupled to a system bus 104, which connects a plurality of system components. For example, the system bus 104 often is connected to a graphics processing unit (GPU) 106, a controller 108, a memory 110, a removable-media drive 112, and video/audio output circuitry 114.

In operation, removable media such as a compact disc (CD) 116 (FIG. 1A) is placed into the removable-media drive 112, which reads data from the disc 116 and transfers program information to the memory 110. The CPU 102, in conjunction with the GPU 106, executes program instructions from the memory 110 to execute the program. In addition, the controller 108 serves as a user input device, such as a game controller, remote controller, keyboard, or other device capable of receiving and transferring user input data to the interactive content system 100. Output from the program executing on the CPU 102 generally is provided to the video/audio output circuitry 114 for presentation, typically on television or other monitor and speaker system 118.

In this manner, users are able to interact with the information presented to them via the controller 108 the screen (not shown) and the discs 116. This information may concern the subject of a video game to be played interactively, and may be in the form of digital data and instructions. However, as can be appreciated, the user is limited to interacting with the information provided from the removable media disc 116 via the removable-media drive 112. For example, if a user purchases a football game, the removable media CD only provides content for the purchased football game. If a user wants to play another game, the user needs to purchase another game CD and then insert it into the game console 101. Consequently, producers and manufacturers of game CD are required to separately package each game, individually ship each game to stores, and separately sell such game CDs.

Recently, however, the storage capability of CDs, such as DVDs, has increased substantially. Many times, the game content stored on an individual CD only takes up a fraction of the available space on the CD. Consequently, the CD containing a particular game is sold with a great deal of unused and wasted bandwidth. Although the cost of physical CDs, in a blank and unused state, has gone down in recent years, the overhead for packaging each CD, transporting CDs to stores, and displaying CDs on store shelves has gone up significantly as the cost of doing business continues to increase.

In view of the foregoing, there is a need for an interactive content system and method that can provide content-related options to purchasers of game CDs.

### SUMMARY OF THE INVENTION

Broadly speaking, the present invention fills these needs by providing a computer driven method that enables purchasers of video games to interactively obtain additional related digital content. The method and system render the content-related options easily available to the user. The method and system provide access to the content-related options from sources such as the Internet (i.e., web sites or servers), and enable easy use of the content-related options in conjunction with interactive applications.

In one embodiment, a method for providing media content-related options in conjunction with video game use is provided. The method includes identifying video game content of a video game and identifying commercial media content that is related to the video game content. The method further includes displaying an interactive menu through a screen of the video game. The interactive menu itemizes selectable commercial media content and provides a link to a commercial Internet website to enable purchase of the commercial media content.

In another embodiment, a method for presenting additional digital content options to video game players of a video game is disclosed. The method includes receiving digital data for a main video game and displaying options for additional digital content. The additional digital content is related to the main video game. The method further includes detecting a selection of at least one of the options for additional digital content and obtaining the selected additional digital content over a network. The method then enables storing the selected additional digital content to local storage.

In still another embodiment, a method for presenting additional digital content options to video game players of a video game is disclosed. The method includes receiving digital data for a main video game and displaying options for additional digital content. The additional digital content being related to the main video game and being locally stored in a locked state. The method further includes detecting a selection of at least one of the options for additional digital content and obtaining a key for the selected additional content. The key operating to unlock the selected additional content.

In another embodiment, a computer video game product is provided. The product includes a computer-readable medium having computer-readable instructions and data recorded thereon for enabling a processor of a computer system to provide commercial media content-related options in conjunction with use of a video game. The instructions and data define video game content readable by the processor to enable playing of the video game through one or more screens. The instructions and data further include identification of commercial media content that is related to the video game content, and instructions for displaying an interactive menu through a screen of the video game. The interactive menu itemizes selectable commercial media content to be read by the processor.

In yet another embodiment, a system for providing commercial media content-related options in conjunction with video game use is disclosed. The system includes a computer-readable medium having recorded thereon computer-readable video game content instructions and data and code identifying the commercial media content that is related to the video game content. The system further includes a video game computer console capable of reading the instructions and data. The video game computer console is configured to display an interactive menu through a screen of the video game. The interactive menu is based on the code of the commercial media content, and the interactive menu itemizes selectable commercial media content to be displayed by the computer console.

In one aspect of the invention, the obtained additional content related options can be locally stored onto free bandwidth of a game CD or can be stored to other local media. In another aspect of the invention, the user is provided with options for additional digital content, and the digital content is at least partially related to the digital content of the purchased game CD. For instance, if the game CD is a car racing game, the user may be provided with options to obtain additional racing-type games. The options, however, are not limited to additional games, but can include any digital content. Such digital content can include, for example, music, videos, screen savers, theme songs, mini-games, etc. So long as the digital content can be saved in digital form, that digital content can be presented as an option to the user of the video game.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1A is a schematic diagram showing a typical interactive content system;

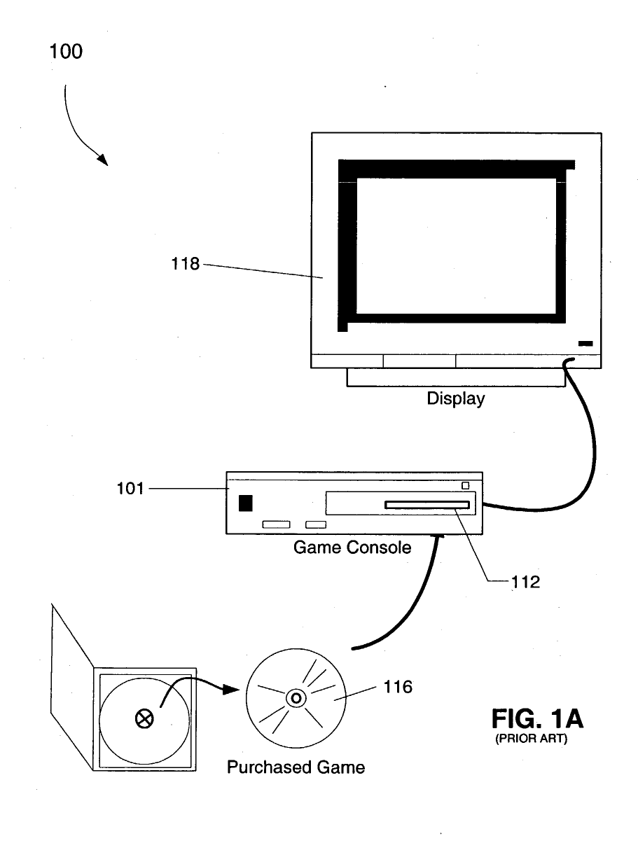

FIG. 1B is a block diagram of basic circuit components of a game console;

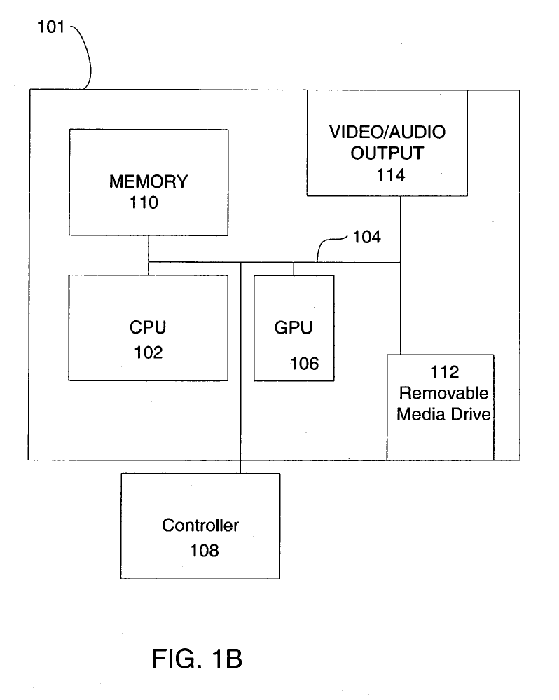

FIG. 2A is a plan view showing a blank disc for receiving digital content;

FIG. 2B is a plan view showing an embodiment of the invention, where additional code is stored on compact disc to enable presentation or access to additional content that may be related to the main video game;

FIG. 2C shows the storage of a second game onto extra previously unused space of the compact disc;

FIG. 2D illustrates the storage of a variety of digital content on a compact disc, such digital content may be downloaded onto the compact disc or activated if already on the disc;

FIG. 3 illustrates an example where additional content that was previously stored on the compact disc (in addition to the main video game) is decrypted using a downloaded key;

FIGS. 4-6 illustrate systems that enable the utilization of compact disc storage or peripheral storage to obtain and store additional digital content that may be related to a main game;

FIG. 7A is a view showing a first, or exemplary, screen of the computer video game, illustrating an option to access content-related options;

FIG. 7B illustrates an exemplary screen that will enable a user to access digital content options that relate to a main video game;

FIGS. 8A and 8B illustrate flow charts operations that enable users to obtain keys for decrypting related digital content stored on the compact disc (or some other local storage);

FIG. 9 is a flow chart illustrating an embodiment where related digital content is identified, purchased, downloaded and stored in local storage.

### DETAILED DESCRIPTION OF THE PREFERRED EMBODIMENTS

An invention is disclosed for a computer driven method that enables purchasers of video games to obtain additional related digital content. The digital content can be obtained from the Internet and stored onto the same media that the purchased video game resides or can be stored onto other local storage. In one embodiment, the additional digital content, which is related by some link to the purchased video game, will preferably already be stored on the media holding the purchased video game. In such an embodiment, the additional digital content only needs to be activated. Activation of the additional digital media can be by way of a digital key that can be purchased over the Internet, for example. Still further, in one embodiment, compact discs may be distributed for free (e.g., in magazines or some other channel) and the user desiring to activate the content stored on the compact disc can simply perform a e-commerce transaction to obtain a key (e.g., over the Internet). In one embodiment, the method and system will render the content-related options easily available to the user of the interactive content system (e.g., game console) by using graphical user displays and selection menus.

Broadly speaking, embodiments of the present invention may include an interactive content product, such as an exemplary computer program video game product. The product may be in the form of a computer-readable medium having computer-readable instructions and data recorded thereon for enabling a processor of a computer system to play video games and provide the user with content related options. The instructions and data preferably include instructions for displaying an interactive menu through a screen of the video game, the interactive menu itemizing selectable media content-related options. These options can either be to augment the content of the purchased video game, or can be selections of other related media content, such as another game, a mini game, a video, a song or songs, a screen saver, etc. The options can be initially stored on the media, or can be obtained from the internet in real-time. If obtained from the Internet in real-time, the user will be provided with a more current list of related digital content.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to obscure the present invention.

Further, in a general sense, the term “game content” or “video game content” will be utilized in the following description to generally indicate any data usable in an interactive application, wherein subject matter of the interactive application has a distinctive characteristic. For example, the interactive application may be a computer video game related to a sport, such as baseball, football, basketball, or the like. One of many sport-related distinctive characteristics of such interactive application may, for example, be the type of sport (e.g., baseball); or who is playing the sport (women, men or children); or whether the sport is amateur or professional (e.g., WN-BA, NFL, NHL, etc.). The video game data and instructions are also generally in digital form and may be stored on a computer-readable medium, such as a CD, CDR, CD-RW, DVD, hard drive, Internet storage, floppy disc, memory stick, or other magnetic or optical data storage device. Also, the term “content-related option” will be utilized in the following description to generally indicate any data usable with or at least partially related to the game content, of such interactive application. Also, the “option” aspect of such term indicates the ready availability of the data and instructions at the selection, or “option”, of the user of the interactive application, i.e., at the option of the person interacting with the computer video game. As another example, if a video game related race cars, related content may be, for example, mini-games for motorcycle racing, speedboat racing, video clips of past actual races, music from the race car video game, etc.

As another example, in a general sense, “content-related option” may be a movie that has the same distinctive characteristic as the interactive application. In the context of an interactive application in the form of a computer video game related to a well-known character, such as Bat Man, for example, the movie may be a list of “Bat Man Movies.” The option can also be a super hero mini-game, or songs from the movie or game, etc.

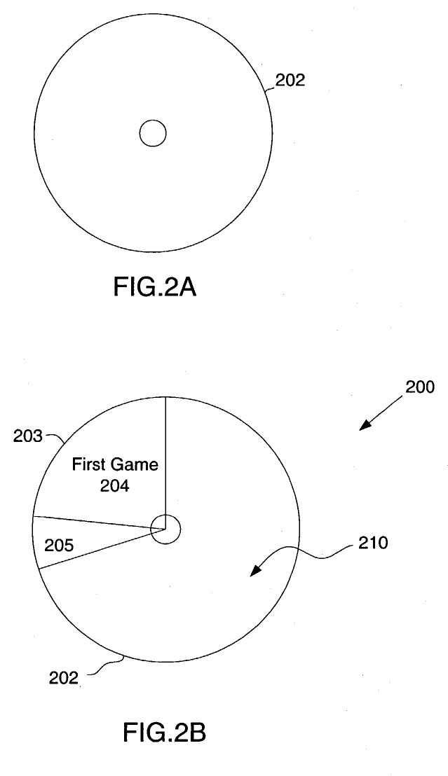

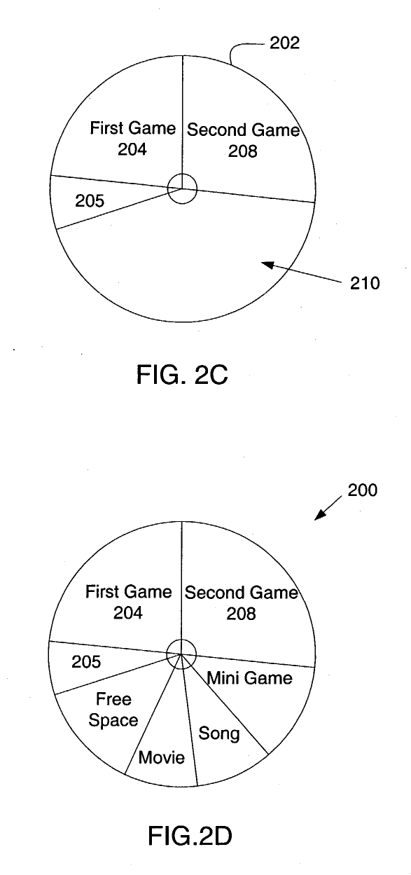

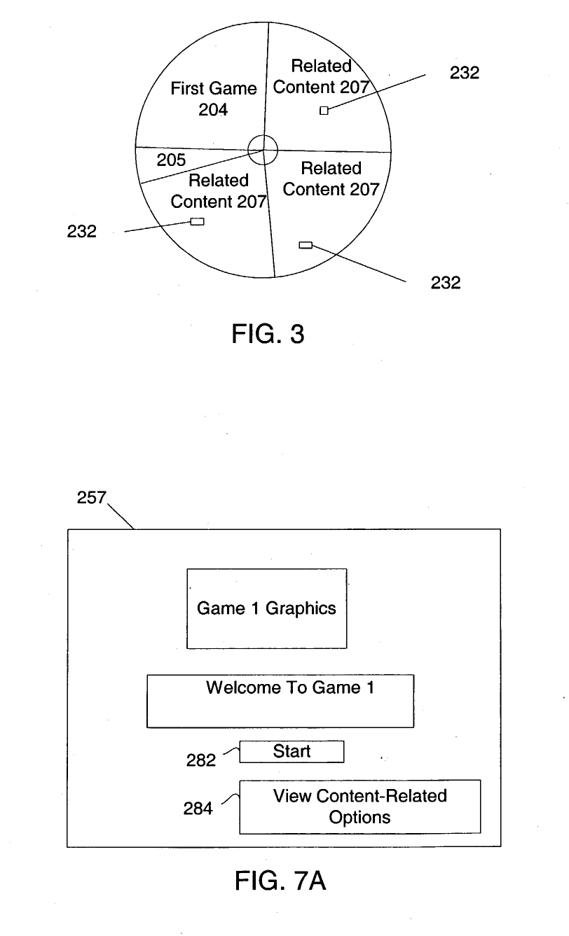

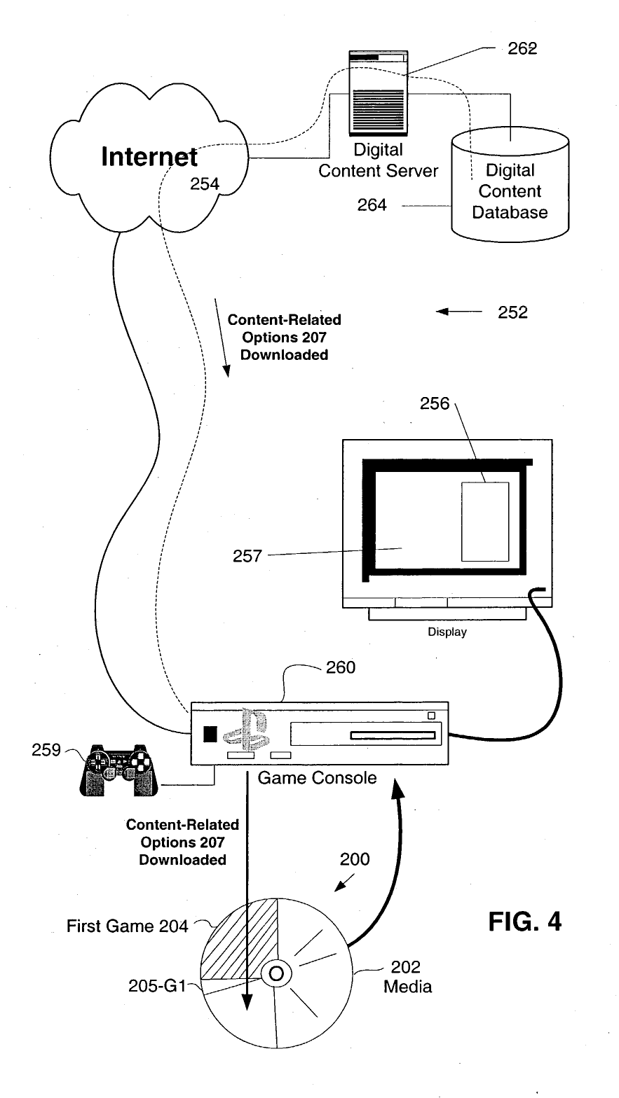

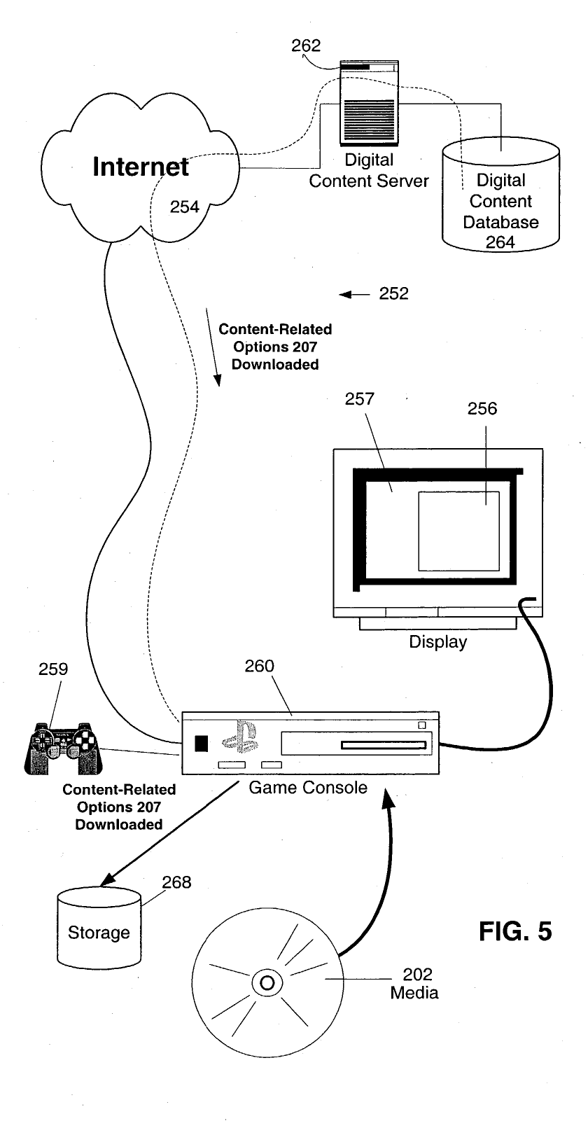

FIG. 2A shows a blank disc medium 202, before data and instructions for a game or related content has been recorded thereon. FIG. 2B shows a first embodiment of a computer program video game product 200. As shown, game data and instructions for a first game 204 is stored on the disc medium 202. It is to be understood that the pictorial illustrations of FIGS. 2B, 2C, 2D and 3 only illustrate what data is stored thereon. Thus, these figures are not intended to represent the manner in which such data is stored. Rather, normal data sectors and normal data accesses are used, such as by an optical disc drive, for example.

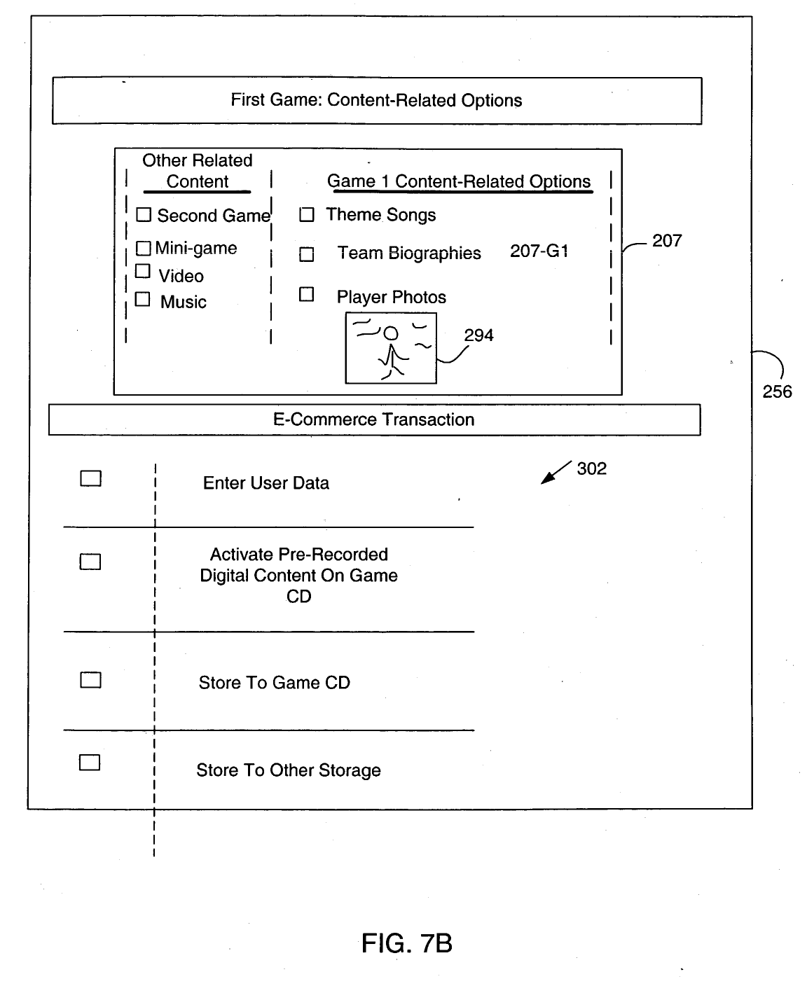

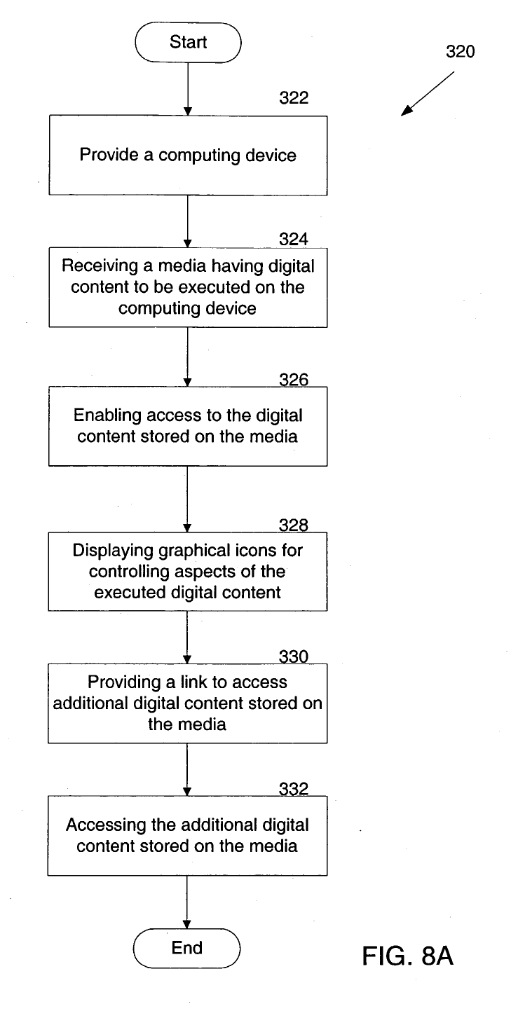

Still referring to FIG. 2B, the stored first game 204 is the main game for which the product 200 was purchased. In one embodiment, additional content data 205 is provided on the product 200. The additional content data 205 is the code that will enable the presentation of related content options to a user during, before or after playing the main game 204. As shown in FIG. 7B, the additional content data 205 is what will enable the display of the content related options 207. In one embodiment, the additional content data 205 will simply be an Internet link to related content or will be the actual related content. As mentioned above, if the actual related content is stored on the medium 202, that content will have to be enabled.

The enabling may be, for example, by logging into a commercial website to purchase a key to unlock the related content. Alternatively, the user will be able to download the related content and write it directly to the disc that contains the first game 204. To download the content, the user will be prompted to complete an e-commerce transaction. In one embodiment, the additional content data 205 will include short samples of the related content. Such samples will allow a user to determine whether her/she actually wants to purchase a full version of the related content. Although the additional content data 205 is shown as a separate segment of data on the medium 202, it should be appreciated that he additional content data 205 can well be part of the first game 204. Accordingly, the inclusion of a separate segment for 205 in FIG. 2C, 2D and 3 is only to emphasize that the medium 202 will include code for presenting additional related media options to users of the first video game 204.

FIG. 2B also shows a portion 210 of unused bandwidth sufficient for storing data for the additional related content, if purchased by the user. FIG. 2C illustrates the recording of a second game 208 in the portion 210. In an alternate embodiment, the second game 208 may have already been recorded on the medium 202, and unlocking is the only step needed to activate the second game (if a key is purchased, for example).

The term “unused bandwidth”, as used herein indicates that when a user of the first game 204 purchases the computer program video game product 200, the portion 210 provides space for other data to be recorded thereon. As a result, the portion 210 is “unused” and available to receive, and store or record, data and instructions corresponding to any content-related option 207 that is to be included on the product 200. In this regard, it may be understood that a standard “blank” DVD medium 202has data and instruction storage capacity of about 4.3Gb. A typical video game such as the first game 204, may only take up one third to half the available bandwidth. If an option 207 is a second game 208, then the portion 210 is also available (i.e., if sufficient) for storage of the data and instructions for the second game 208. If the portion 210 is not sufficiently large for the second game 208, the user will be advised through a text or message.

In one embodiment, the options 207 provided to the user will be pre-screened on-the-fly to determine if they fit on the portion 210. For instance, after the user stores the second game 208 on the unused portion 210, the portion 210 will be smaller and thus not capable of storing some games or related options. Upon storing new data to the portion 210, the code in 205 will determine the available space and only display as options 207 that data that can fit in the remaining portion 210. In this manner, the user is not provided with options that are not capable of fitting on the medium 202. Still further, if certain options do not fit on the medium 202, the options will still be provided. However, the options will also provide the user with some indication that the content will have to be stored on another storage device, other than the medium 202 (e.g., on a hard drive, memory stick, etc.).

FIG. 2D shows an embodiment in accordance with the present invention, where the portion 210 is pre-recorded with content related options. In this example, the product 200 comes with a mini-game, a song or songs, a movie, and free space. If the product 200 comes with this pre-recoded related content, the user can activate that content by going to an appropriate e-commerce website. In combination with this embodiment, the user can also use the free space to add other content related options 207 (see FIG. 7B), if space is available.

FIG. 3 illustrates a first video game 204 having additional content data 205, and three other related content 207 portions. Each related content option is preferably locked at the time of purchase of the first game 204. For instance, the first game might be a football game, and the other three related options might be basketball, hockey, and baseball. It is very likely that the purchaser of the football game might have an interest in one or more of the other three options. To avoid extra trips to the store, the user can simply link to an e-commerce website (i.e., as assisted by the additional content data 205 code) and activate the additional games. The related content 207 is, as mentioned above, locked by a suitable encryption key 232. The encryption key 232 can be opened using a suitable decryption key. The decryption key is what is purchased during the e-commerce transaction.

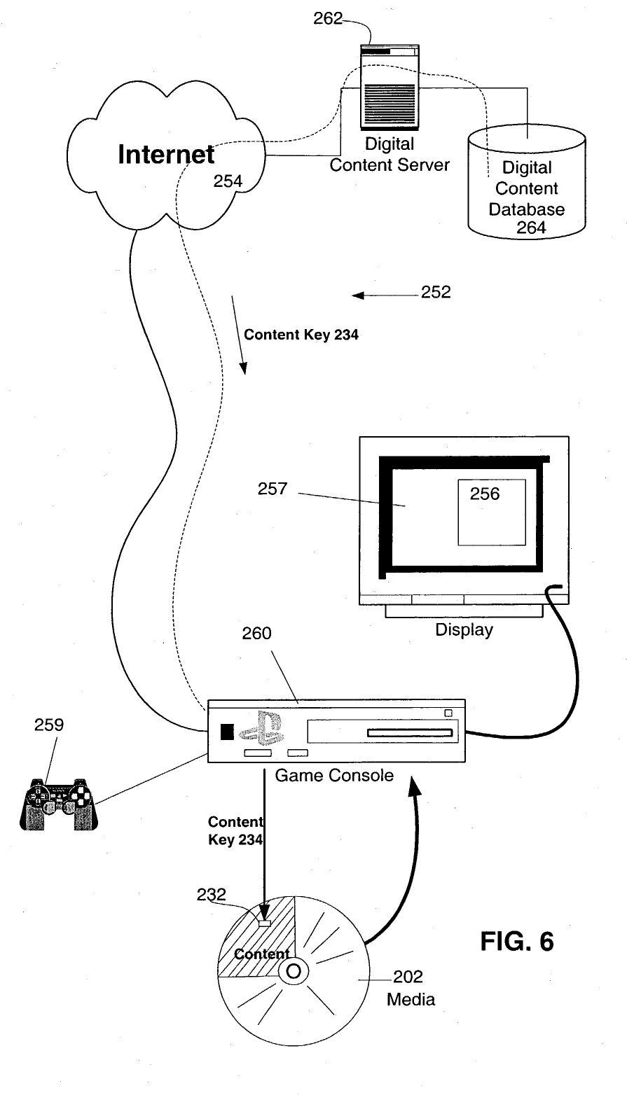

FIG. 4 shows an embodiment of the interactive content system 252 in accordance with the present invention. The system shows a digital content server 262 that is coupled to a digital content database 264. The game console 260 is shown connected to the digital content server 262 through the Internet 254, using any wired or wireless connection. The digital content server may, in one embodiment, be one or more servers that provide access to digital content. The options 207, in one embodiment, may actually be stored on the digital content database 264. In this manner, the options 207 can be presented to the user in real-time, and can be updated at any time. For instance, if the first video game 204 is Madden 2000, the options 207 that are stored on the digital content database would be updated to include other games, such as Madden 2001, Madden 2002, and Madden 2003, for example. The additional content data 205, in this example, would simply be a link to the digital content server 262. The digital content server 262 would then data mine the digital content database 264 to then provide updated options 207 to the user.

In either embodiment, once the digital content is selected by the user, the user is prompted to complete an e-commerce transaction. Once the transaction is complete and approved, the content related option(s) 207 are downloaded to the game console 260. The game console 260, using optical writing code will burn the purchased content onto the media 202. Optical writing code is well known to those skilled in the art. In the example of FIG. 4, the purchased option may be a second game 208 as shown in FIG. 2C.

In one embodiment, the user of the game console can simply use the game controller 259 to navigate the options or Internet during the e-commerce transaction. In still another embodiment, a user can be linked to a website and pointed to related content that can be purchased (e.g., such additional games). The additional games can then be downloaded to the optical media 202 at that time, or the downloading can be done at a later time. Purchased digital media can be temporarily stored at a site or address for later retrieval and recording.

FIG. 5 shows another embodiment of the interactive content system 252 in accordance with the present invention. A reference number shown in FIG. 4 refer to the same item. FIG. 5 shows an alternate storage device 268, such as a separate disk drive, that may be used for storing data and instructions downloaded from the Internet 254, for example. By making an e-commerce transaction facilitated in the same manner as described above with respect to FIG. 4, a second game 208, or other content-related options 207 may be downloaded to the storage device 268, rather than onto media 202. The downloading onto the storage device 268 may be also facilitated by use of an interactive option menu 256 on the screen 257 connected to the video game console 260 of the system 252. Through the controller 259, the option menu 256 may be navigated.

FIG. 6 shows another embodiment of the interactive content system 252 in accordance with the present invention. A reference number shown in both FIGS. 4 and 5 refer to the same item. In this example, the medium 202 in FIG. 6 includes only one game, which is currently locked. In this embodiment, a user may obtain the media 202 for free, as an insert to a magazine or through the mail. The media 202 will include basic code 205 to prompt the user to an e-commerce website to enable the purchase of a content key 234. As shown, once the media 202 is inserted into the game console 260, the user will be prompted through a guided menu to enable purchase of the content key 234. The content key 234, as shown, can be downloaded from a digital content database 264 over the Internet 254. The content key 234 will then unlock the encryption key 232 that locks the content on the media 202.

FIG. 7A shows an example of a screen 257, in accordance with one embodiment of the present invention. The screen 257 may be presented to the user upon inserting a game compact disc. The screen 257 is shown to be generic, however, one skilled in the art will understand that a typical screen will have well defined graphics, animation, and accompanying music and sounds. For purposes of discussion only, the user may have purchased a football game, and the graphics for Game 1, may be a football helmet that rotates. As is typical in video games, the user will be prompted to start the game by selecting an icon 282 or pushing a button on the controller. Selecting the icon 282 will either start the game immediately or move the user to another screen where other selections regarding the game skill level, environment, duration, etc., may be selected.

As part of the usual set up, the user may be provide with an option to jump to another screen where content related options are provided. As mentioned above, the content related options 207 are essentially digital content that can be purchased or sampled. The digital content, in a preferred embodiment will have some relation to the first game 204 (i.e., the main game product 200).

In another embodiment, the user can return to the main screen 257 and select to view content related options by selecting icon 284. The selection of icon 284 will move the user to a screen or sets of screens that will enable selection of particular content related options. FIG. 7B illustrates an example where a first game provides certain related options 207. For instance, the game related options may be content that relates directly to the game 1, such as options 207-G1. These options that related directly to game 1 may, for instance, enhance the game 1 itself. In the example provide herein, the user may choose to add special theme songs to the game play. For example, if a user gets excited when listening to Elvis music, the user may want to incorporate Elvis songs into the game 1 play. If game 1 is a football game, the user may want to obtain team biographies of the players for the current year, or current player photos. Before these game enhancements are purchased, the user is provided with the option of viewing sort video samples in sub-screen 294, or listen to short clips of songs.

In another embodiment, the options 207 may be other related content. Other related content may be, for example, a second game, a mini-game, a video, or music. Thus, other related content will not enhance the first game, but will provide additional digital content that can be downloaded or activated. Once the user makes its selections, the user will be prompted to complete an e-commerce transaction. The e-commerce transaction may include options 302. Options 302 request the entering of user data, activate pre-recorded digital content on a game CD, store new content to the game CD, or store digital content to other storage.

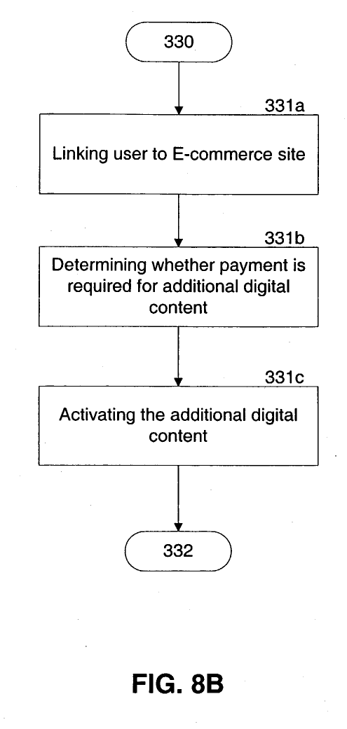

FIG. 8A shows a flowchart 320 defining method operations performed when additional digital content stored on a compact disc media is enabled through an e-commerce transaction, in accordance with one embodiment of the present invention. The method begins at operation 322 where a computer device is provided. The computer device, as described above, may be a game console that is designed to play video games. The video games are typically stored on a compact disc, and the compact disc is inserted into the game console computing device where instructions stored on the compact disc are executed. When the computer instructions are executed, the user may interact with the video game whether it be during setup operations or during actual play.

The method now moves to operation 324 where a media having digital content to be executed on the computer device is received. As mentioned above, the media may be a compact disc or other device having digital content that is to be received and executed by the computing device. The method then moves to operation 326 where access to the digital content stored on the media is enabled. Access to the digital content stored on the media is provided by loading the compact disc and executing the program instructions. Enabling access to the digital content stored on the media may also be in the form of providing interactive access to the video game or setup screens provided by the particular game.

The method now moves to operation 328 where graphical icons for controlling aspects of the executed digital content is displayed. The graphical icons may be in the form of graphics, animation, and action that may be part of the game. In addition to displaying graphical icons, the user may be provided with options to select menus either before play, during play, or after play. The method now moves to operation 330 where a link is provided to access additional digital content stored on the media. In this embodiment, the compact disc that holds the main game may also include other digital content that may be related to the main game.

Although the user may not have purchased the game to obtain the additional content, the additional content may be of interest to the user because it relates to the game that the user purchased. As mentioned above, if the user purchased a football game, the additional digital content stored on the media may be a basketball game. For the user, having access to this additional digital content that may already be stored on the compact disc is beneficial for many reasons. For example, the user will find it more efficient to simply activate the additional digital content stored on the same compact disc instead of having to make a special trip to the store to purchase the game. Additionally, the producer of the video game may provide the game at discount to the user compared to purchasing the game separately in its own case at the store. The discount may be warranted since the manufacturer or designer of the video game will not have to invest in packaging, shipping, and display shelf time in stores.

The method then moves to operation 332 where the additional digital content stored on the media is accessed. Accessing the additional digital content stored on the media may be facilitated, as shown in FIG. 8B.

FIG. 8B illustrates a flowchart where the link provided in operation 330 moves to operation 331a. In operation 331a, the user will be provided with a link to an e-commerce site. The e-commerce site may be the site of a game manufacturer, or a third party that produces some digital content. Once the user is linked to an e-commerce site, the method moves to operation 331bwhere it is determined whether payment is required for the additional digital content.

In some embodiments, the additional digital content may be a mini-game that has restricted access to particular features. In such a case, the mini-game may be provided for free and the e-commerce site will not require payment from the user. However, the user would still, in one embodiment, be required to sign up at the e-commerce site so the producer of the mini-game will know the identify of the person that downloaded the sample mini-game product. In this manner, the manufacturer can then follow-up with the user to determine whether the user wants to purchase the full game at a later time. The method now moves to an operation 331cwhere the additional digital content is activated to allow the user to fully access the digital content in operation 332 of FIG. 8A.

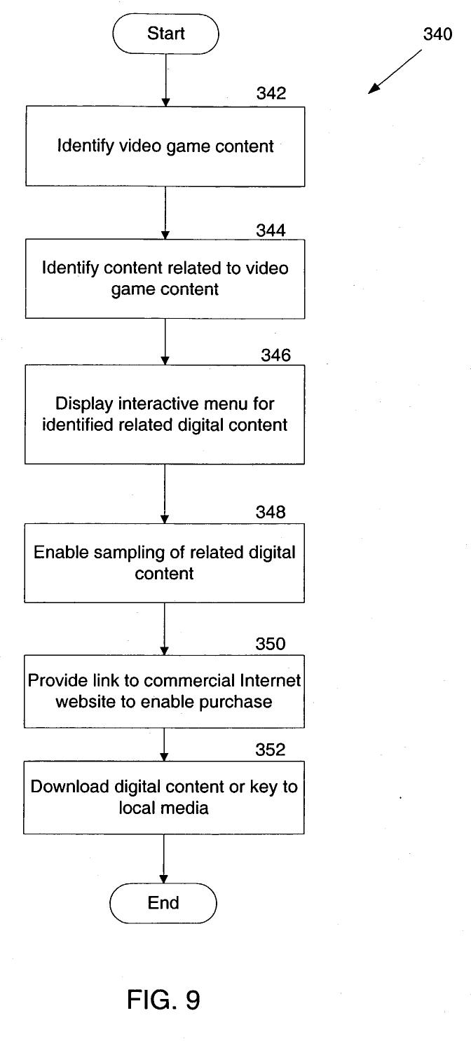

FIG. 9 illustrates a flowchart 340 where the user is provided with the option of obtaining additional related content, and then storing the additional related content to a local media. The method begins at operation 342 where video game content is identified. In one embodiment, the video game content that is identified is the first game that was purchased with the compact disc. The method then moves to operation 344 where content related to the video game content is identified.

The content related to the video game may be resident on the compact disc itself in identification section 205, or may be dynamically provided to the user from the Internet. In either case, the content related to the video game will need to be identified and presented to the user. The method now moves to operation 346 where an interactive menu for the identified related digital content is displayed to the user. As mentioned above, the interactive menu may be provided at the beginning of the video game play, during video game play, or after video game play. In either embodiment, the user is provided with the interactive menu so that selection of particular related digital content can be identified for purchase.

The method now moves to operation 348 where sampling of the related digital content that may have been selected in operation 346 is enabled. The sampling may be in the form of providing mini-games, sample music clips, sample video clips, or other samples to enable evaluation of the additional digital content to be purchase. In an alternative embodiment, the samples do not have to be provided, and the user will simply be required to purchase the digital content selected in operation 346.

The method now moves to operation 350 where a link to the commercial Internet web site is provided to enable purchase of the digital content. As mentioned earlier, the commercial Internet web site may be the web site for the same company that produced the video game, or other companies that may want to promote video games or mini-games to the user of a particular game. Once the user completes the e-commerce transaction in operation 350, the method moves to operation 352 where the digital content or key to unlock the digital content is downloaded to the local media from the Internet.

As mentioned above, the digital content itself may be downloaded or, in the alternative, a simple decryption key may be downloaded to unlock content that may already reside on the compact disc. Once downloaded, the user can then access the digital content stored on the local media (compact disc, hard disc, or other storage). In one embodiment, the additional digital content that was either downloaded or activated will be secured or encrypted to prevent additional unauthorized reproduction.

Although the foregoing invention has been described in some detail for purposes of clarity of understanding, it will be apparent that certain changes and modifications may be practiced within the scope of the appended claims. For instance, related digital content can be any data, so long as the data can be stored in digital form. The relation, in the broadest terms, can be any relation, so long as some logical or marketing link can be made. Accordingly, the present embodiments are to be considered as illustrative and not restrictive, and the invention is not to be limited to the details given herein, but may be modified within the scope and equivalents of the appended claims.

What is claimed is:

1. A method for providing media content-related options in conjunction with video game use, comprising the operations of:
identifying commercial media content that is related to a video game content;
displaying an interactive menu through a screen of the video game, the interactive menu itemizing selectable ones of the commercial media content;
providing a link to a commercial Internet website to enable purchase of the commercial media content.

2. A method for providing media content-related options in conjunction with video game use as recited in claim 1, further comprising:
providing a sample of a selected one of the commercial media content from the interactive menu.

3. A method for providing media content-related options in conjunction with video game use as recited in claim 1, wherein the commercial media content is one of a game, a movie, a song, and a video.

4. A method for providing media content-related options in conjunction with video game use as recited in claim 1, further comprising an operation of:
storing the purchased commercial media content to a storage device in an encrypted format.

5. A method for providing media content-related options in conjunction with video game use as recited in claim 4, wherein the encrypted format prevents copying of the commercial media content to an alternative storage device.

6. A method for providing media content-related options in conjunction with video game use as recited in claim 1, wherein the video game content is for a particular type of game.

7. A method for providing media content-related options in conjunction with video game use as recited in claim 1, wherein the interactive menu is selectable through a user input device.

8. A method for providing media content-related options in conjunction with video game use as recited in claim 1, wherein the video game is run on a game console.

9. A method for providing media content-related options in conjunction with video game use as recited in claim 1, wherein the game console is connected to the Internet.

10. A computer video game product, comprising:
a computer-readable medium having computer-readable instructions and data recorded thereon for enabling a processor of a computer system to provide commercial media content-related options in conjunction with use of a video game, the instructions and data comprising:
video game content readable by the processor to enable playing of the video game through one or more screens;
identification of commercial media content that is related to the video game content; and
instructions for displaying an interactive menu through a screen of the video game, the interactive menu itemizing selectable ones of the commercial media content to be read by the processor.

11. A computer video game product as recited in claim 10, wherein the instructions and data further comprise:
instructions to provide a sample of a selected one of the commercial media content from the interactive menu.

12. A computer video game product as recited in claim 11, wherein the instructions and data further comprise:
instructions to provide a link to a commercial Internet website to enable purchase of a selected one of the commercial media content.

13. A computer video game product as recited in claim 10, the instructions and data further comprising:
at least one selected one of the commercial media content with an encryption routine to prevent copying of the at least one selected one of the commercial media content to an alternative storage device, access to the at least one selected one of the commercial media content being authorized by a key; and
instructions to provide a link to a commercial Internet website to enable purchase of the key to the selected commercial media content and access by the processor to the selected commercial media content in conjunction with the use of the video game.

14. A computer video game product as recited in claim 10, wherein the computer-readable medium further comprises:
a portion of unused bandwidth sufficient for storing at least one selected one of the commercial media content to enable the processor to process the at least one selected commercial media content.

15. A computer video game product as recited in claim 9, wherein commercial media content that is related to the video game content is one of a movie, music, a game, a mini game, a video, and a song.

16. A computer program video game product as recited in claim 10, wherein the processor of the computer system is in a video game console.

17. A computer program video game product as recited in claim 16, wherein the game console is connected to the Internet.

18. A system for providing commercial media content-related options in conjunction with video game use, the system comprising:
a computer-readable medium having recorded thereon computer-readable video game content instructions and data and code identifying the commercial media content that is related to the video game content; and
a video game computer console capable of reading the instructions and data, the video game computer console being configured to display an interactive menu through a screen of the video game, the interactive menu being based on the code of the commercial media content, the interactive menu itemizing selectable ones of the commercial media content to be displayed by the computer console.

19. A system as recited in claim 18, wherein the video game computer console is further configured to provide access to the Internet by which access to the selectable ones of the commercial media content may be purchased to enable the selected commercial media content.

20. A system as recited in claim 19, wherein the instructions and data further comprise a selected one of the commercial media content recorded on the computer-readable medium with an encryption routine, a key not recorded on the medium controlling access by the computer console to the selected commercial media content, and the access to the Internet enabling purchase of the key for use of the selected commercial media content.

21. A system as recited in claim 18, wherein the computer-readable medium further comprises:
unused bandwidth sufficient for storing the selected commercial media content to enable the computer console to process the selected commercial media content and the video game.

22. A video game system to provide Internet access to video game computer programs and commercial media content that is related to content of the video game computer programs, the video game system comprising:
a video game computer console capable of reading video game instructions and data; and
a computer-readable medium adapted to record thereon computer-readable instructions and data, the instructions and data comprising video game content readable by the video game computer to enable playing of the video game through at least one video game screen, the instructions and data further including code enabling the identification or link to commercial media content options that relate to the video game content;
the video game computer console being configured for displaying an interactive menu through a screen, the interactive menu displaying the commercial media content options;
the video game computer console being further configured to provide access to the Internet to obtain or activate at least one selectable commercial media option.

23. A method for presenting additional digital content options to video game players of a video game, comprising:
receiving digital data for a main video game;
displaying options for additional digital content, the additional digital content being related to the main video game;
detecting a selection of at least one of the options for additional digital content;
obtaining the selected additional digital content over a network; and
storing the selected additional digital content to local storage.

24. A method for presenting additional digital content options to video game players of a video game as recited in claim 23, wherein the main video game is stored on a compact disc.

25. A method for presenting additional digital content options to video game players of a video game as recited in claim 24, wherein the displayed options for additional digital content are stored in one of the compact disc and the Internet.

26. A method for presenting additional digital content options to video game players of a video game as recited in claim 25, wherein when the displayed options for the digital content are stored on the Internet, the displayed options are current related options.

27. A method for presenting additional digital content options to video game players of a video game as recited in claim 23, wherein the local storage is a compact disc that contains the main game or is other local storage.

28. A method for presenting additional digital content options to video game players of a video game as recited in claim 27, wherein other local storage is one of a hard drive, a memory stick, a magnetic storage device, and digital storage device.

29. A method for presenting additional digital content options to video game players of a video game, comprising:
receiving digital data for a main video game;
displaying options for additional digital content, the additional digital content being related to the main video game and being locally stored in a locked state;
detecting a selection of at least one of the options for additional digital content; and
obtaining a key for the selected additional content, the key operating to unlock the selected additional content.

30. A method for presenting additional digital content options to video game players of a video game as recited in claim 29, wherein the digital data for the main video game and the additional digital content are stored on a same media.

31. A method for presenting additional digital content options to video game players of a video game as recited in claim 29, wherein the same media is a compact disc.

32. A method for presenting additional digital content options to video game players of a video game as recited in claim 30, wherein the displayed options for additional digital content are stored on the same media.

33. A computer video game product, comprising:
a computer-readable medium having program instructions and data, the computer video game product enabled to present additional digital content options to video game players of a video game, the program instructions further comprising:
program instructions for receiving digital data for a main video game;
program instructions for displaying options for additional digital content, the additional digital content being related to the main video game;
program instructions for detecting a selection of at least one of the options for additional digital content;
program instructions for obtaining the selected additional digital content over a network; and
program instructions for storing the selected additional digital content to local storage.

34. A computer video game product as recited in claim 33, wherein the main video game is stored on a compact disc.

35. A computer video game product as recited in claim 33, wherein the displayed options for additional digital content are stored in one of the compact disc and the Internet.

36. A computer video game product as recited in claim 35, wherein when the displayed options for the digital content are stored on the Internet, the displayed options are current related options.

37. A computer video game product, the computer game product enabling presentation of additional digital content options to video game players of a video game, the computer game product comprising:
program instructions for receiving digital data for a main video game;
program instructions for displaying options for additional digital content, the additional digital content being related to the main video game and being locally stored in a locked state;
program instructions for detecting a selection of at least one of the options for additional digital content; and
program instructions for obtaining a key for the selected additional content, the key operating to unlock the selected additional content.

38. A computer video game product as recited in claim 37, wherein the digital data for the main video game and the additional digital content are stored on a same media.

39. A computer video game product as recited in claim 38, wherein the same media is a compact disc.

40. A computer product, comprising:
program instructions for identifying commercial media content that is related to a video game content; and
program instructions for displaying an interactive menu through a screen of the video game, the interactive menu itemizing selectable ones of the commercial media content.

41. A computer product as recited in claim 40, further comprising:
program instructions for providing a link to a commercial Internet website to enable purchase of the commercial media content.
